(19) United States
(12) Patent Application Publication
(10) Pub. No.: US 2025/0159580 A1
(43) Pub. Date: May 15, 2025

(54) WIRELESS COMMUNICATION METHOD AND WIRELESS COMMUNICATION SYSTEM

(71) Applicant: NIPPON TELEGRAPH AND TELEPHONE CORPORATION, Tokyo (JP)

(72) Inventors: Hisayoshi KANO, Musashino-shi, Tokyo (JP); Munehiro MATSUI, Musashino-shi, Tokyo (JP); Junichi ABE, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/834,351

(22) PCT Filed: Feb. 1, 2022
(86) PCT No.: PCT/JP2022/003881

§ 371 Date: Jul. 30, 2024

(51) Int. Cl. H04W 40/02; H04W 40/24

(52) U.S. Cl. CPC H04W 40/02; H04W 40/248

(57) ABSTRACT

A wireless communication method according to an embodiment is a wireless communication method in which a plurality of moving node stations each equipped with a transmission buffer transmit data via switchable wireless communication paths, the wireless communication method including: an acquisition step of acquiring correspondence information corresponding to an amount of data transmitted by each of the node stations each time a communication status varies; a changing step of changing a cost value per unit link speed between the plurality of node stations on the basis of each piece of the acquired correspondence information; a calculation step of calculating cost values among the plurality of node stations using the changed cost values; and a determination step of determining, as a communication path, a path with a minimum sum of the calculated cost values.

### TECHNICAL FIELD

The present invention relates to a wireless communication method and a wireless communication system.

### BACKGROUND ART

In recent years, a mobile communication system has developed, and mobile services can be enjoyed over most of the ground. In addition, super coverage is one of requirements in a fifth generation (Beyond 5G) or a sixth generation mobile communication system expected to be commercialized in the future.

Super coverage means expanding a service area to a place where it is expensive to lay an existing base station, such as a mountain, on the sea, or in the air, or to a place where it is difficult to lay a base station. In addition, national resilience against natural disasters and the like is also required, and the appearance of a communication system resistant to ground disasters is desired.

In order to achieve such a wireless communication system, a non-terrestrial network (NTN) using a geostationary earth orbit satellite, a medium earth orbit satellite (MEO), a low earth orbit satellite (LEO), a high altitude platform station satellite (HAPS), an unmanned aerial vehicle (UAV), a drone, and the like has attracted attention (see, for example, Non Patent Literature 1).

In the NTN, the satellite and the HAPS connect communication links to each other to form a network, and are further connected to a mobile network on the ground via a ground base station. The satellites and the HAPS are equipped with mobile base station functions.

Then, traffic packets transmitted by a terminal station are transferred to the satellite and the HAPS connected to the ground base station by a routing function, and are sent to the Internet network. Packets transmitted from the Internet network to another terminal station are also subjected to similar processing by the routing function.

### CITATION LIST

### Non Patent Literature

Non Patent Literature 1: Yuta Tada, et al., “A Study on an Efficient Route Control Method for Two-Layered Satellite Networks”, IEICE Technical Report, Institute of Electronics, Information and Communication Engineers, 2010, pp. 45-50

### SUMMARY OF INVENTION

### Technical Problem

In a network having a large difference in delay and speed for each communication link such as an NTN, a method of calculating a cost value for each link and determining a path has been studied. For example, when a communication path is determined in the NTN, a path with the minimum sum of cost values calculated for each communication link is selected as the communication path.

However, in wireless communication in a high frequency band used by satellites, HAPS, and the like, there is a problem that traffic concentrates on some links with low cost values and congestion may occur when a communication status varies due to rain attenuation or the like.

The present invention has been made in view of the above-described problems, and an object of the present invention is to provide a wireless communication method and a wireless communication system capable of efficiently performing wireless communication while reducing traffic concentration on a specific communication path even when a communication status between a plurality of wireless communication devices varies.

### Solution to Problem

A wireless communication method according to an embodiment of the present invention is a wireless communication method in which a plurality of moving node stations each equipped with a transmission buffer transmit data via switchable wireless communication paths, the wireless communication method including: an acquisition step of acquiring correspondence information corresponding to an amount of data transmitted by each of the node stations each time a communication status varies; a changing step of changing a cost value per unit link speed between the plurality of node stations on the basis of each piece of the acquired correspondence information; a calculation step of calculating cost values among the plurality of node stations using the changed cost values; and a determination step of determining, as a communication path, a path with a minimum sum of the calculated cost values.

In addition, a wireless communication system according to an embodiment of the present invention is a wireless communication system in which a plurality of moving node stations each equipped with a transmission buffer transmit data via switchable wireless communication paths, the wireless communication system including: an acquisition unit configured to acquire correspondence information corresponding to an amount of data transmitted by each of the node stations each time a communication status varies; a changing unit configured to change a cost value per unit link speed between the plurality of node stations on the basis of each piece of the correspondence information acquired by the acquisition unit; a calculation unit configured to calculate cost values among the plurality of node stations using the cost values changed by the changing unit; and a determination unit configured to determine, as a communication path, a path with a minimum sum of the cost values calculated by the calculation unit.

### Advantageous Effects of Invention

According to the present invention, even when a communication status between a plurality of wireless communication devices varies, it is possible to efficiently perform wireless communication while reducing traffic concentration on a specific communication path.

### BRIEF DESCRIPTION OF DRAWINGS

FIG. 1 is a diagram illustrating a configuration example of a wireless communication system according to an embodiment.

FIG. 2 is a diagram illustrating a configuration example of a node station.

FIG. 3 is a diagram illustrating a configuration example of a route control unit.

FIG. 4 is a flowchart illustrating a first operation example of the wireless communication system according to the embodiment.

FIG. 5 is a diagram illustrating the first operation example of the wireless communication system according to the embodiment.

FIG. 6 is a flowchart illustrating a second operation example of the wireless communication system according to the embodiment.

FIG. 7 is a diagram illustrating the second operation example of the wireless communication system according to the embodiment.

FIG. 8 is a flowchart illustrating a third operation example of the wireless communication system according to the embodiment.

FIG. 9 is a flowchart illustrating a fourth operation example of the wireless communication system according to the embodiment.

FIG. 10 is a diagram illustrating the fourth operation example of the wireless communication system according to the embodiment.

FIG. 11 is a diagram illustrating a configuration of a modification example of a network control device in the wireless communication system according to the embodiment.

FIG. 12 is a diagram illustrating a configuration example of a wireless communication system.

### DESCRIPTION OF EMBODIMENTS

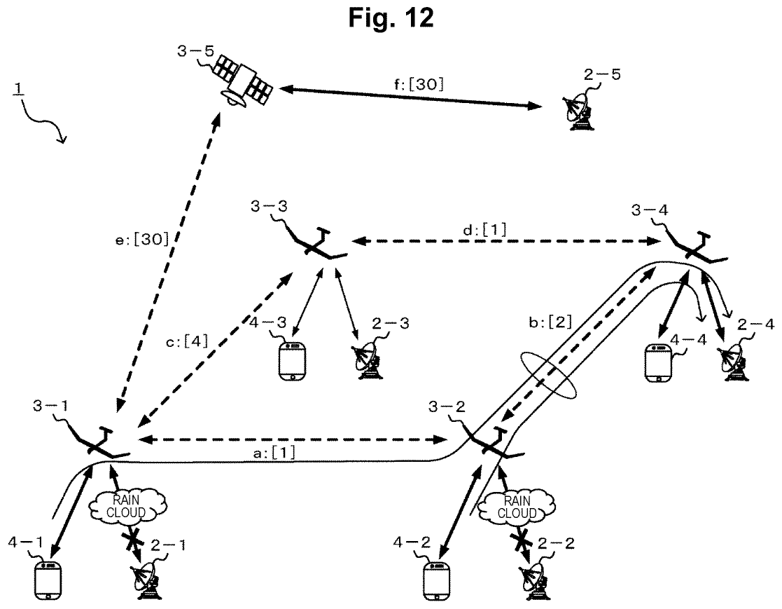

First, the background of the present invention will be described with reference to FIG. 12. FIG. 12 is a diagram illustrating a configuration example of a wireless communication system 1. As illustrated in FIG. 12, the wireless communication system 1 includes, for example, base stations (ground base stations) 2-1 to 2-5 and node stations 3-1 to 3-5, and a plurality of terminal stations (ground terminal stations) 4-1 to 4-4 can be connected to each other.

The node stations 3-1 to 3-5 are wireless communication devices that move on the non-ground such as unmanned aerial vehicles or satellites, each have a mobile base station function, and connect communication links a to f, for example, to form an NTN.

When determining a communication path, the wireless communication system 1 selects, as the communication path, a path with the minimum sum of cost values calculated for each communication link. The cost value is calculated by the following formula (1). For example, a link speed and a link delay are fixed values set by a user.

$$[ Math . 1 ]$$

$$\frac{Reference value of speed}{Link speed} + \frac{Link delay}{Reference value of delay} \qquad ( 1 )$$

For example, when the reference value of the speed is 100 Mbps, the cost value of a communication link of 10 Mbps is “10”, and the cost value of a communication link of 100 Mbps is “1”. That is, a communication link of 10 Mbps has a cost value per unit link speed (for example, 1 Mbps) of 10 times that of a communication link of 100 Mbps. Then, the wireless communication system 1 selects a higher-speed communication link.

In addition, when the reference value of the delay is 1 s, the cost value of a communication link with a delay of 10 ms is “100”, and the cost value of a communication link with a delay of 100 ms is “10”. Then, the wireless communication system 1 selects a lower-delay communication link.

In this way, the wireless communication system 1 is configured to calculate the cost value according to the above formula (1) and to easily select the high-speed and low-delay communication link as the communication path.

In the example illustrated in FIG. 12, for example, it is assumed that the cost value of the communication link a is “1”, the cost value of the communication link b is “2”, the cost value of the communication link c is “4”, the cost value of the communication link d is “1”, the cost value of the communication link e is “30”, and the cost value of the communication link f is “30”.

For example, when a communication link (feeder link) between the base station 2-1 and the node station 3-1 and a communication link (feeder link) between the base station 2-2 and the node station 3-2 are blocked by rain clouds or the like (when communication is disabled), the wireless communication system 1 transfers traffic (data) to a node station having a feeder link capable of communicating with the base station (ground base station).

At this time, the wireless communication system 1 selects a communication path with the minimum sum of cost values. That is, the terminal station 4-1 is connected to the base station 2-4 via the communication links a and b in which the sum of the cost values is 3 (=1+2), which is the minimum. The terminal station 4-2 is connected to the base station 2-4 via the communication link b in which the sum of the cost values is 2, which is the minimum.

Therefore, traffic from the terminal station 4-1 and traffic from the terminal station 4-2 concentrate on the communication link b, and congestion may occur.

Therefore, a wireless communication system 1a according to an embodiment described below is configured to be able to efficiently perform wireless communication while reducing traffic concentration on a specific communication path even when a communication status between a plurality of wireless communication devices varies.

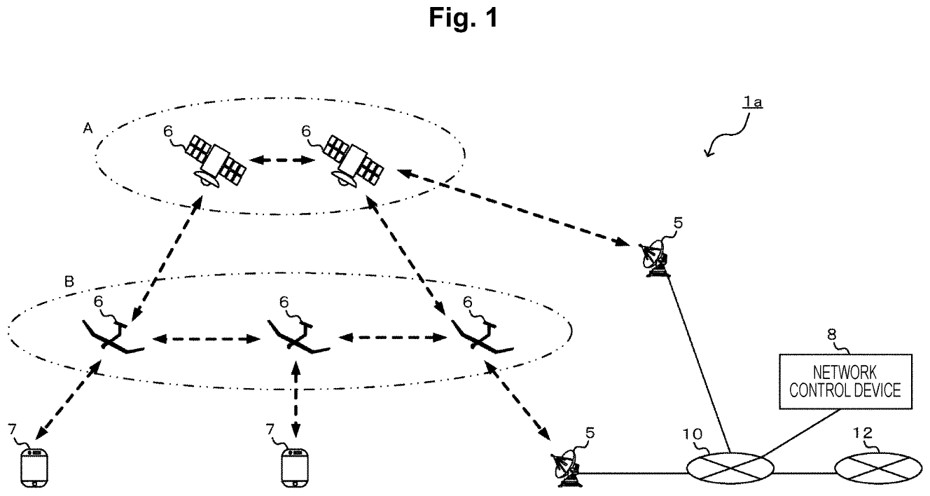

FIG. 1 is a diagram illustrating a configuration example of a wireless communication system 1a according to an embodiment. As illustrated in FIG. 1, the wireless communication system 1a according to the embodiment includes, for example, a plurality of base stations (ground base stations) 5 and a plurality of node stations 6, and a plurality of terminal stations (ground terminal stations) 7 can be connected to each other.

The node station 6 is a geostationary earth orbit satellite (GEO), a medium earth orbit satellite (MEO), a low earth orbit satellite (LEO), a high altitude platform station satellite (HAPS), a drone, an unmanned aerial vehicle (UAV), an aircraft, or the like.

Each of the node stations 6 connects the communication links to each other and also connects the communication links to the base station 5 to form a network for each type of node station. For example, a node station network A includes a plurality of node stations 6 that are geostationary earth orbit satellites, and a node station network B includes a plurality of node stations 6 that are unmanned aerial vehicles.

In addition, each of the plurality of base stations 5 is connected to a network control device 8 and an Internet network 12 via a mobile network 10. The network control device 8 acquires information from each node station 6 and the like via the mobile network 10. The network control device 8 may periodically acquire information, or may receive information from the node station 6 when an event such as feeder link disconnection occurs.

When specifying any of a plurality of configurations, such as the node station 6, a node station 6-1, a node station 6-2, a node station 6-3, . . . are described and distinguished.

Each of the node stations 6 is a wireless communication device that moves on the non-ground such as a moving unmanned aerial vehicle or satellite equipped with a transmission buffer, has a mobile base station function including a routing function, and connects communication links to form an NTN.

Then, when the plurality of node stations 6 transmit data via switchable wireless communication paths, the wireless communication system 1a selects, as the communication path, a path with the minimum sum of cost values calculated for each communication link.

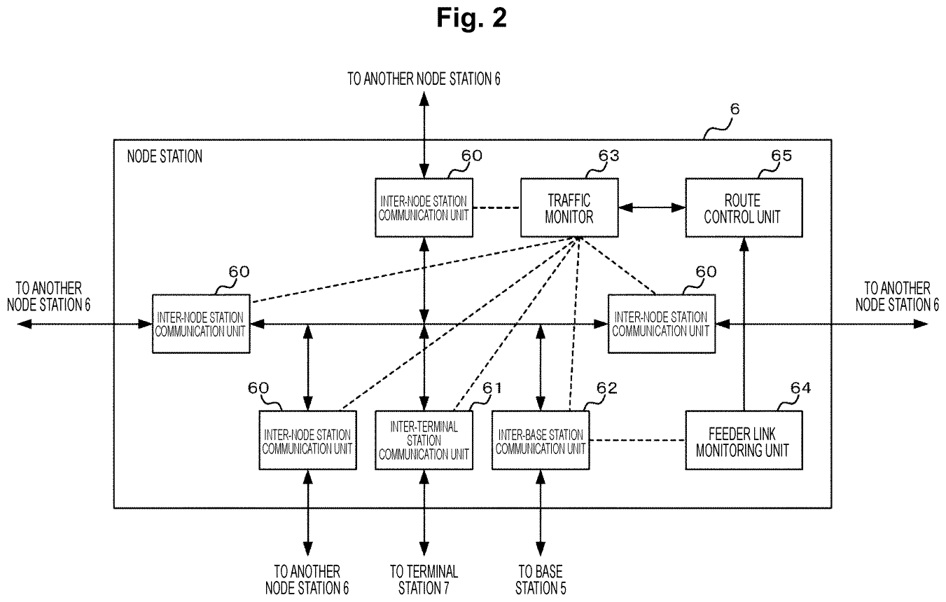

FIG. 2 is a diagram illustrating a configuration example of the node station 6. As illustrated in FIG. 2, the node station 6 includes, for example, a plurality of inter-node station communication units 60, an inter-terminal station communication unit 61, an inter-base station communication unit 62, a traffic monitor 63, a feeder link monitoring unit 64, and a route control unit 65.

The inter-node station communication unit 60 performs wireless communication by connecting a communication link with another adjacent node station 6. The inter-terminal station communication unit 61 performs wireless communication by connecting a communication link with the terminal station 7 in a predetermined communication area. The inter-base station communication unit 62 performs wireless communication by connecting a communication link with the base station 5 in a predetermined communication area.

The traffic monitor 63 detects, for example, the traffic volume of each of the respective inter-node station communication units 60, the inter-terminal station communication unit 61, and the inter-base station communication unit 62, and outputs each of the detected traffic volumes to the route control unit 65. In addition, the traffic monitor 63 measures the usage status of the transmission buffer of the corresponding node station 6.

The feeder link monitoring unit 64 monitors the feeder link performed by the inter-base station communication unit 62 and outputs a result of the monitored feeder link to the route control unit 65.

The route control unit 65 calculates a cost value of each of the plurality of communication links of the wireless communication system 1a on the basis of, for example, the traffic volume and the usage status of the transmission buffer input from the traffic monitor 63 and the result of the feeder link input from the feeder link monitoring unit 64, and determines and controls a communication path (route) or the like of packets (data) to be transmitted in the wireless communication system 1a.

That is, the route control unit 65 calculates a cost value, exchanges a cost value with another adjacent node station 6, and determines a communication path of traffic.

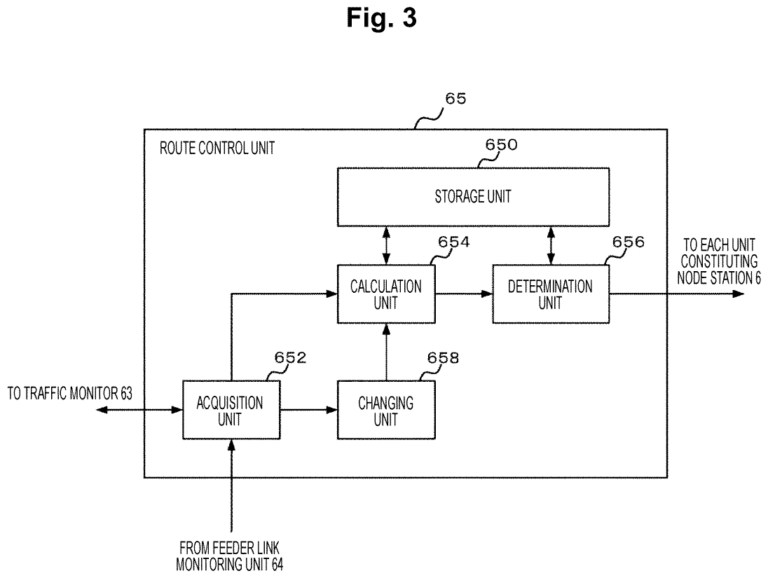

FIG. 3 is a diagram illustrating a configuration example of the route control unit 65. As illustrated in FIG. 3, the route control unit 65 includes, for example, a storage unit 650, an acquisition unit 652, a calculation unit 654, a determination unit 656, and a changing unit 658.

The storage unit 650 is a memory or the like, stores, for example, data necessary for the route control unit 65 to calculate the cost value of each of the plurality of communication links and control the communication path, and outputs the stored data according to access from the calculation unit 654 and the determination unit 656.

The acquisition unit 652 acquires each of the traffic volume and the usage status of the transmission buffer output by the traffic monitor 63, the result of the feeder link output by the feeder link monitoring unit 64, and the like, and outputs them to the calculation unit 654 and the changing unit 658.

For example, the acquisition unit 652 acquires the correspondence information corresponding to the amount of data transmitted by each of the node stations 6 each time the communication status varies, and outputs the correspondence information to the calculation unit 654 and the changing unit 658.

More specifically, the acquisition unit 652 acquires the usage rate of the transmission buffer of each node station 6 as the correspondence information. In addition, the acquisition unit 652 may acquire, as the correspondence information, the amount of data obtained by subtracting the amount of data newly input to the corresponding node station 6 due to the switching of the communication path from the amount of data transmitted by the node station 6. In addition, the acquisition unit 652 may acquire a carrier-to-noise ratio (C/N) of data received by each of the node stations 6 as correspondence information.

The calculation unit 654 calculates a cost value using each of the data stored in the storage unit 650 and the correspondence information (traffic volume and the like) acquired by the acquisition unit 652, and calculates a cost value between the plurality of node stations 6 using the calculated cost value. Then, the calculation unit 654 outputs the calculated cost value between the plurality of node stations 6 to the storage unit 650 and the determination unit 656.

In addition, when the changing unit 658 to be described later changes the cost value, the calculation unit 654 calculates the cost value between the plurality of node stations 6 using the cost value changed by the changing unit 658.

The determination unit 656 determines, as a communication path, a path with the minimum sum of the data stored in the storage unit 650 and the cost value calculated by the calculation unit 654, and outputs information indicating the determined communication path to each unit constituting the node station 6.

Furthermore, when the cost values of all the communication paths calculated by the calculation unit 654 are equal to or greater than a predetermined threshold value, the determination unit 656 may determine a predetermined specific communication path as a communication path for specific data.

The changing unit 658 changes the cost value per unit link speed between the plurality of node stations 6 on the basis of each piece of the correspondence information acquired by the acquisition unit 652, and outputs the changed cost value to the calculation unit 654.

That is, when the communication status of the communication link in the wireless communication system 1a varies, the calculation unit 654 calculates the cost value between the plurality of node stations 6 using the cost value changed by the changing unit 658 according to the communication status. Then, the determination unit 656 performs adaptive control to determine a communication path in the wireless communication system 1a according to the variation in the communication status of the communication link.

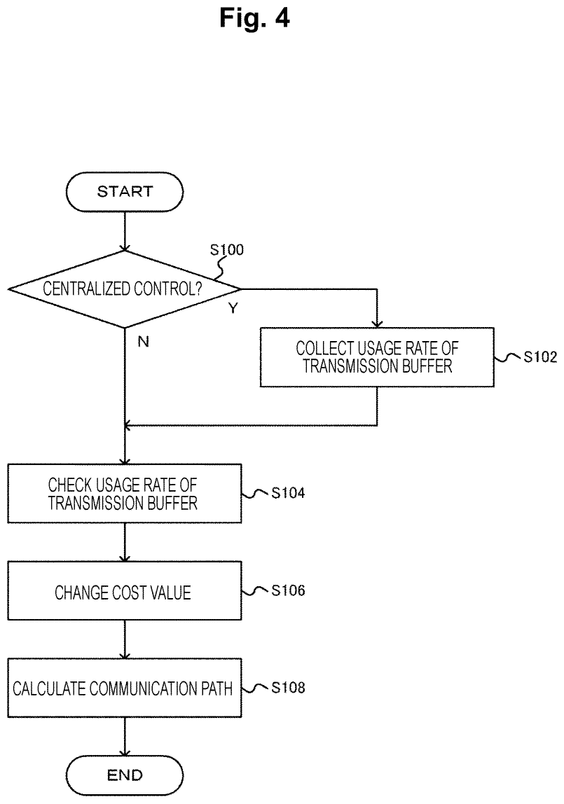

Next, more specific operation examples (first to fourth operation examples) of the wireless communication system 1a will be described. FIG. 4 is a flowchart illustrating a first operation example of the wireless communication system 1a according to the embodiment.

As illustrated in FIG. 4, in step 100 (S100), the wireless communication system 1a determines, for example, whether or not the node station 6 performs centralized control of determination of communication paths. The node station 6 proceeds to the process of S102 when centralized control is to be performed (S100: Yes), and proceeds to the process of S104 when centralized control is not to be performed (S100: No).

In step 102 (S102), the node station 6 collects the usage rate of the transmission buffer from each node station 6.

In step 104 (S104), the node station 6 checks the usage rate of the transmission buffer of each node station 6. For example, the node station 6 checks whether or not there is a variation in the communication status that requires a change in the cost value by using the usage rate of the transmission buffer of each node station 6.

In step 106 (S106), the node station 6 changes the cost value of each communication link according to the usage rate of the transmission buffer.

In step 108 (S108), the node station 6 calculates the communication path with the minimum total cost value of the communication links by using the changed cost value.

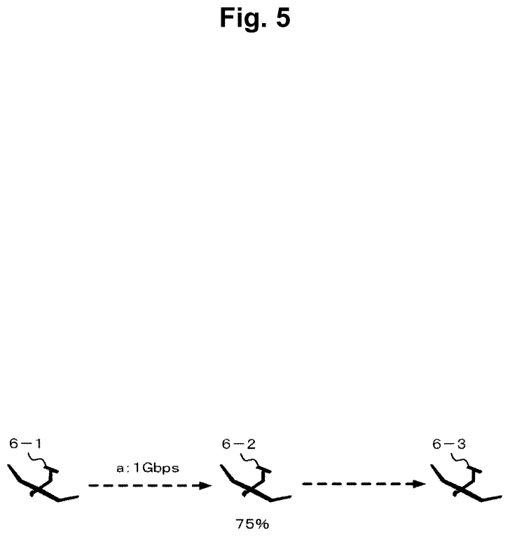

FIG. 5 is a diagram illustrating the first operation example of the wireless communication system 1a according to the embodiment. As illustrated in FIG. 5, for example, the node station 6-1 transmits 1 Gbps of data to the node station 6-2 via the communication link a, and transmits the data to the node station 6-3 via the node station 6-2.

The node station 6 changes the cost value of the communication link according to the usage rate of the transmission buffer. The transmission buffer usage rate is calculated by the following formula (2).

$$[ Math . 2 ]$$

$$Transmission buffer usage rate = \frac{Total size of packets stored in transmission buffer [ bytes ]}{Transmission buffer size [ bytes ]} \qquad ( 2 )$$

The cost value at this time is calculated by the following formula (3).

$$[ Math . 3 ]$$

$$\frac{Reference value of link speed}{\begin{matrix}Link speed \times \\ ( \frac{1 - Transmission buffer usage rate of node station}{Number of input links to node station} )\end{matrix}} + \frac{Link delay}{Reference value of link delay} \qquad ( 3 )$$

Here, it is assumed that the number of input links to the node station 6-2 is 1 and the buffer usage rate is 75%. Traffic that can be input from the communication link a to the node station 6-2 is 1 Gbps×(1-0.75)=0.25 Gbps.

In this case, the node station 6-2 changes the cost value by setting the link speed of the communication link a to 0.25 Gbps.

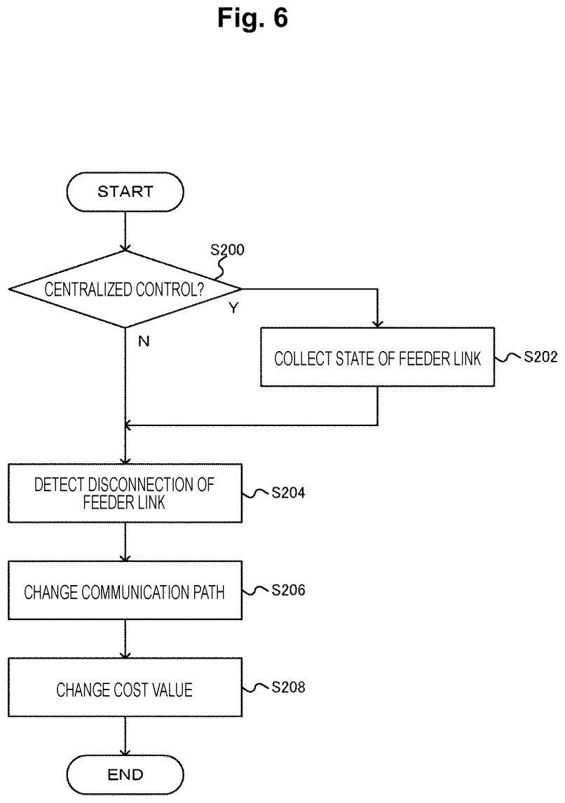

FIG. 6 is a flowchart illustrating a second operation example of the wireless communication system 1a according to the embodiment. As illustrated in FIG. 6, in step 200 (S200), the wireless communication system 1a determines, for example, whether or not the node station 6 performs centralized control of determination of communication paths. The node station 6 proceeds to the process of S202 when centralized control is to be performed (S200: Yes), and proceeds to the process of S204 when centralized control is not to be performed (S200: No).

In step 202 (S202), the node station 6 collects the state of the feeder link from each node station 6.

In step 204 (S204), the node station 6 detects disconnection of the feeder link.

In step 206 (S206), the node station 6 calculates a communication path with the minimum total cost value, and changes the communication path.

In step 208 (S208), the node station 6 changes the cost value of the communication route included in the new communication path.

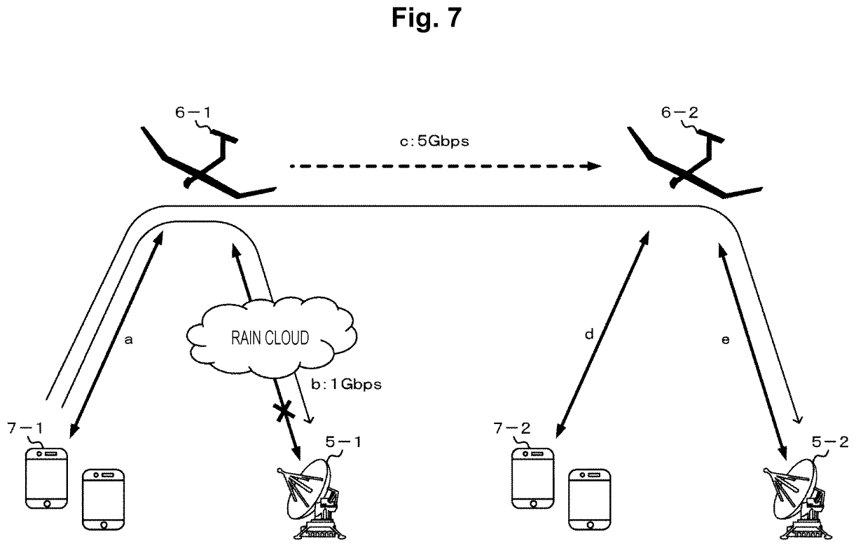

FIG. 7 is a diagram illustrating the second operation example of the wireless communication system 1a according to the embodiment. As illustrated in FIG. 7, for example, a terminal station 7-1 tries to transmit 1 Gbps of data to the base station 5-1 via the communication links a and b. At this time, when the feeder link (communication link b) between the node station 6-1 and the base station 5-1 is disabled due to rainfall or the like, the wireless communication system 1a switches to a new communication path via the communication links a, c, and e, and then changes the cost value of the communication route included in the new communication path. In this case, the terminal station 7-1 transmits data to another base station (base station 5-2) via the node station 6-1 and the node station 6-2.

Specifically, the node station 6 calculates the cost value by the following formula (4).

$$[ Math . 4 ]$$

$$\frac{Reference value of link speed}{Link speed - Speed of feeder link} + \frac{Link delay}{Reference value of link delay} \qquad ( 4 )$$

Assuming that traffic of the maximum link speed (1 Gbps) of the feeder link for which communication is disabled is input to the communication link c included in the new communication path, the wireless communication system 1a calculates a changed cost value with a link speed of 4 Gbps obtained by subtracting 1 Gbps from the link speed (5 Gbps) of the communication link c. That is, even if the link speed of the communication link c is 5 Gbps, the node station 6-2 calculates the cost value assuming that the link speed of the communication link c is 5 Gbps−1 Gbps=4 Gbps.

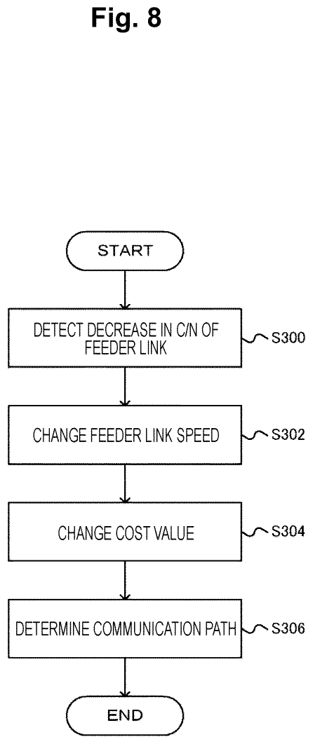

FIG. 8 is a flowchart illustrating a third operation example of the wireless communication system 1a according to the embodiment. As illustrated in FIG. 8, in step 300 (S300), the wireless communication system 1a detects a decrease in C/N reception of the feeder link.

In step 302 (S302), the node station 6 changes the feeder link speed according to the reception C/N.

In step 304 (S304), the node station 6 changes the cost value according to the changed feeder link speed.

In step 306 (S306), the node station 6 calculates the communication path with the minimum total cost value by using the changed cost value.

That is, in the third operation example, the wireless communication system 1a adaptively controls the link speed according to the reception C/N of the feeder link (reduces link speed to continue communication when reception c/n decreases due to rainfall or the like), and calculates the cost value according to the changed link speed.

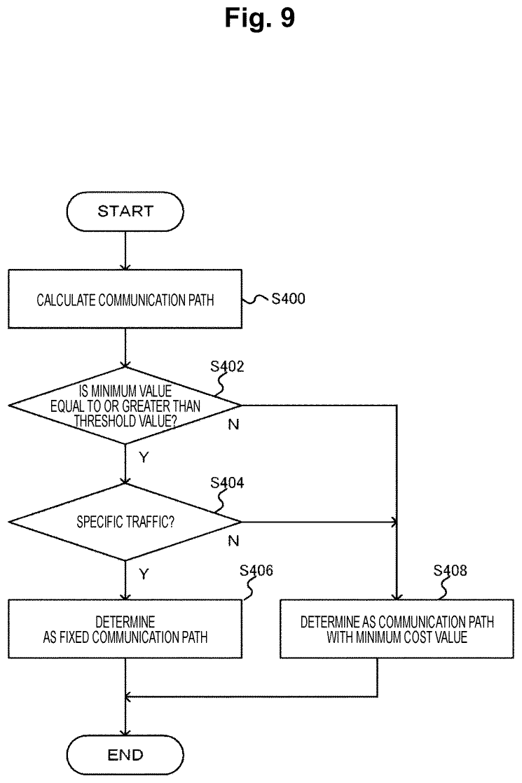

FIG. 9 is a flowchart illustrating a fourth operation example of the wireless communication system 1a according to the embodiment. As illustrated in FIG. 9, in step 400 (400), the wireless communication system 1a calculates a communication path with the minimum total cost value.

In step 402 (S402), the node station 6 determines whether or not the minimum value of the total cost values is equal to or greater than a predetermined threshold value. The node station 6 proceeds to the process of S404 when the minimum value of the total cost values is equal to or greater than the predetermined threshold value (S402: Yes), and proceeds to the process of S408 when the minimum value of the total cost values is less than the predetermined threshold value (S402: No).

In step 404 (S404), the node station 6 determines whether or not the data to be routed transmitted through the communication path whose minimum value of the total cost values is equal to or greater than the predetermined threshold value corresponds to predetermined specific traffic. The node station 6 proceeds to the process of S406 when the data corresponds to the specific traffic (S404: Yes), and proceeds to the process of S408 when the data does not correspond to the specific traffic (S404: No).

In step 406 (S406), the node station 6 determines the communication path for transmitting the data corresponding to the specific traffic, as a predetermined fixed communication path, regardless of the cost value.

In step 208 (S208), the node station 6 determines the communication path for transmitting data not corresponding to the specific traffic as a communication path with the minimum cost value.

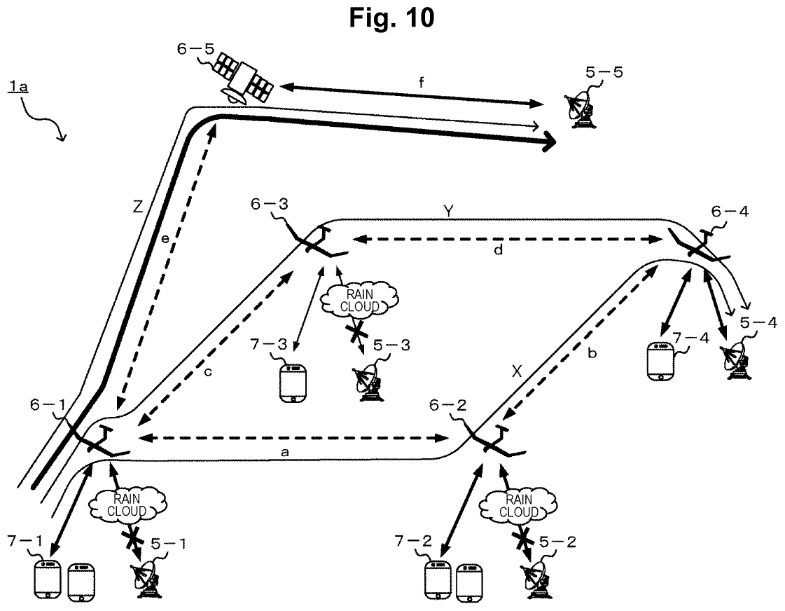

FIG. 10 is a diagram illustrating the fourth operation example of the wireless communication system 1a according to the embodiment. The wireless communication system 1a sets a threshold value for the total cost value, and when the total cost value of all the communication paths is equal to or greater than a predetermined threshold value, it is assumed that all the communication paths are congested. Then, the wireless communication system 1a causes the specific traffic to communicate using a predetermined fixed communication path regardless of the cost value.

In the example illustrated in FIG. 10, it is assumed that a communication link between the node station 6-1 and the base station 5-1, a communication link between the node station 6-2 and the base station 5-2, and a communication link between the node station 6-3 and the base station 5-3 are disabled due to rain clouds or the like.

At this time, in order to transmit data transmitted by the terminal station 7-1, the wireless communication system 1a transfers the data to either the base station 5-4 or the base station 5-5 that can communicate with each other. For example, a communication path X using the communication links a and b, a communication path Y using the communication links c and d, and a communication path Z using the communication links e and f can be used for data transfer.

For example, the total cost value of each of the communication paths X, Y, and Z is as follows.
Communication path X: 20
Communication path Y: 18
Communication path Z: 40

In addition, it is assumed that the threshold value of the total cost value for the communication path is 15. Here, when the data transmitted by the terminal station 7-1 corresponds to the predetermined specific traffic, since the total cost value 18 of the communication path Y with the minimum total cost value exceeds the threshold value 15, the wireless communication system 1a determines the predetermined fixed communication path Z as the communication path of the data transmitted by the terminal station 7-1 regardless of the total cost value.

Note that the node station 6 determines whether or not the traffic is the specific traffic using a QoS class identifier (QCI) from the terminal station 7 or the like. Furthermore, the wireless communication system 1a may be configured to operate by combining the operations from the first to fourth operation examples described above.

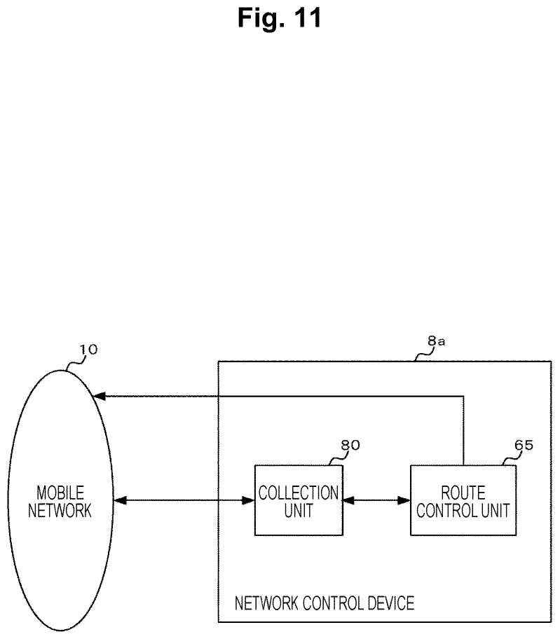

Next, a modification example of the wireless communication system 1a will be described. FIG. 11 is a diagram illustrating a configuration of a modification example (network control device 8a) of the network control device 8 in the wireless communication system 1a according to the embodiment.

The network control device 8a includes, for example, a collection unit 80 and a route control unit 65. The collection unit 80 collects data transmitted via the mobile network 10 and outputs the data to the route control unit 65. The data collected by the collection unit 80 is similar to the data acquired by the node station 6 described above.

For example, the collection unit 80 collects the usage status of the transmission buffer and the feeder link state acquired by each node station 6.

In addition, the network control device 8a has a function (see FIG. 3) similar to that of the route control unit 65 included in the node station 6, and adaptively controls a communication path in the wireless communication system 1a. Therefore, in the wireless communication system 1a, as long as the network control device 8a has the function of adaptively controlling the communication path, each of the node stations 6 may not have the function of adaptively controlling the communication path.

In this way, the wireless communication system 1a acquires the correspondence information corresponding to the amount of data transmitted by each of the node stations 6 each time the communication status varies, and changes the cost value per unit link speed between the plurality of node stations 6 on the basis of each piece of the acquired correspondence information. Therefore, even if the communication status varies among the wireless communication devices such as the plurality of base stations 5, the node stations 6, and the terminal station 7, it is possible to efficiently perform wireless communication while reducing traffic concentration on a specific communication path.

Note that some or all of the functions of each of the base station 5, the node stations 6, the terminal station 7, and the network control devices 8 and 8a may be configured by hardware such as a programmable logic device (PLD) or a field programmable gate array (FPGA), or may be configured as a program executed by a processor such as a CPU.

For example, the wireless communication system 1a according to the present invention can be implemented by using a computer and a program, and the program can be recorded in a storage medium or provided through a network.

### REFERENCE SIGNS LIST

1, 1a Wireless communication system
2, 5 Base station
3, 6 Node station
4, 7 Terminal station
8, 8a Network control device
10 Mobile network
12 Internet network
60 Inter-node station communication unit
61 Inter-terminal station communication unit
62 Inter-base station communication unit
63 Traffic monitor
64 Feeder link monitoring unit
65 Route control unit
80 Collection unit
650 Storage unit
652 Acquisition unit
654 Calculation unit
656 Determination unit
658 Changing unit

1. A wireless communication method in which a plurality of moving node stations each equipped with a transmission buffer transmit data via switchable wireless communication paths, the wireless communication method comprising:
acquiring correspondence information corresponding to an amount of data transmitted by each of the node stations each time a communication status varies;
changing a cost value per unit link speed between the plurality of node stations on the basis of each piece of the acquired correspondence information;
calculating cost values among the plurality of node stations using the changed cost values; and
determining, as a communication path, a path with a minimum sum of the calculated cost values.

2. The wireless communication method according to claim 1,
wherein the acquiring includes acquiring a usage rate of the transmission buffer of each of the node stations as the correspondence information.

3. The wireless communication method according to claim 1,
wherein the acquiring includes acquiring, as the correspondence information, an amount of data obtained by subtracting an amount of data newly input to the node station due to switching of a communication path from the amount of data transmitted by the node station.

4. The wireless communication method according to claim 1,
wherein the acquiring includes acquiring a carrier-to-noise ratio (C/N) of data received by each of the node stations as the correspondence information.

5. The wireless communication method according to claim 1,
wherein the determining includes determining a predetermined specific communication path as a communication path for specific data when cost values of all communication paths calculated in the calculation step are equal to or greater than a predetermined threshold value.

6. A wireless communication system in which a plurality of moving node stations each equipped with a transmission buffer transmit data via switchable wireless communication paths, the wireless communication system comprising:
acquisition circuitry configured to acquire correspondence information corresponding to an amount of data transmitted by each of the node stations each time a communication status varies;
changing circuitry configured to change a cost value per unit link speed between the plurality of node stations on the basis of each piece of the correspondence information acquired by the acquisition circuitry;
calculation circuitry configured to calculate cost values among the plurality of node stations using the cost values changed by the changing circuitry; and
determination circuitry configured to determine, as a communication path, a path with a minimum sum of the cost values calculated by the calculation circuitry.

7. The wireless communication system according to claim 6,
wherein the acquisition circuitry acquires, as the correspondence information, at least one of a usage rate of the transmission buffer of each of the node stations, a C/N of data received by each of the node stations, and an amount of data obtained by subtracting an amount of data newly input to the node station due to switching of a communication path from the amount of data transmitted by the node station.

8. The wireless communication system according to claim 6,
wherein the determination circuitry determines a predetermined specific communication path as a communication path for specific data when cost values of all communication paths calculated by the calculation circuitry are equal to or greater than a predetermined threshold value.
